(19) United States
(12) Patent Application Publication
(10) Pub. No.: US 2023/0042165 A1
(43) Pub. Date: Feb. 9, 2023

(54) LIQUID CRYSTAL POLYMER PARTICLES, METHOD OF PRODUCING SAME, AND COMPOSITE MATERIAL

(71) Applicant: FUJIFILM Corporation, Tokyo (JP)

(72) Inventors: Daisuke HAYASHI, Shizuoka (JP); Keita TAKAHASHI, Shizuoka (JP); Genya TANAKA, Shizuoka (JP); Hirotaka KITAGAWA, Shizuoka (JP)

(73) Assignee: FUJIFILM Corporation, Tokyo (JP)

(21) Appl. No.: 17/857,148

(22) Filed: Jul. 4, 2022

(30) Foreign Application Priority Data
Jul. 30, 2021 (JP) 2021-126193

(51) Int. Cl. C09K 19/38

(52) U.S. Cl. CPC C09K 19/3814; C09K 19/3809

(57) ABSTRACT

Provided are a liquid crystal polymer particle in which a difference in contact angle of the liquid crystal polymer particle with water due to a water droplet in air at 25° C. and 50% RH between inside the particle and a surface of the particle is 7° or greater, a liquid crystal polymer particle in which a difference in atomic ratio of an oxygen atom to a carbon atom measured by X-ray photoelectron spectroscopy between inside a particle and a surface of the particle is 0.02 or greater, a method of producing the liquid crystal polymer particle, and a composite material formed of the liquid crystal polymer particle.

### CROSS-REFERENCE TO RELATED APPLICATION

This application is based on and claims priority under 35 USC 119 from Japanese Patent Application No. 2021-126193, filed Jul. 30, 2021, the disclosure of which is incorporated by reference herein.

### BACKGROUND OF THE INVENTION

### 1. Field of the Invention

The present disclosure relates to liquid crystal polymer particles, a method of producing the same, and a composite material.

### 2. Description of the Related Art

In recent years, the frequencies used in communication equipment tend to be extremely high. In order to suppress transmission loss in a high frequency band, insulating materials used in circuit boards are required to decrease the relative dielectric constant and the dielectric loss tangent.

As liquid crystal polymers of the related art, for example, the liquid crystal polymers described in Japanese Journal of Polymer Science and Technology, Yukihiro Nakano, Hideki Yamane, Yoshiharu Kimura, Toshio Kitao, Vol. 48, No. 6, pp. 381 to 389 (1991) have been known.

Japanese Journal of Polymer Science and Technology, Yukihiro Nakano, Hideki Yamane, Yoshiharu Kimura, Toshio Kitao, Vol. 48, No. 6, pp. 381 to 389 (1991) describes that the liquid crystal polymer is blended with polycarbonate (PC), polyethylene terephthalate (PET), or the like for the purpose of improving the heat resistance and increasing the elastic modulus or the strength.

Further, as liquid crystal polymer particles of the related art, for example, the liquid crystal polymer particles described in WO2017/150336A have been known.

WO2017/150336A describes a resin composition containing at least one resin selected from the group consisting of thermosetting resins and thermoplastic resins, and liquid crystal polymer particles.

### SUMMARY OF THE INVENTION

An object to be achieved by an aspect of the present invention is to provide liquid crystal polymer particles having excellent dispersibility in a resin or a solvent containing a polar group and a method of producing the same.

Further, an object to be achieved by another aspect of the present invention is to provide a composite material containing the liquid crystal polymer particles.

The means for achieving the above-described object includes the following aspects.

<1> A liquid crystal polymer particle, in which a difference in contact angle of the liquid crystal polymer particle with water due to a water droplet in air at 25° C. and 50% RH between inside the particle and a surface of the particle is 7° or greater.

<2> A liquid crystal polymer particle, in which a difference in atomic ratio of an oxygen atom to a carbon atom measured by X-ray photoelectron spectroscopy between inside a particle and a surface of the particle is 0.02 or greater.

<3> The liquid crystal polymer particle according to <1> or <2>, in which the contact angle of the particle with water on the surface of the particle due the water droplet in air at 25° C. and 50% RH is less than 65°.

<4> The liquid crystal polymer particle according to any one of <1> to <3>, in which an atomic ratio of an oxygen atom to a carbon atom measured by X-ray photoelectron spectroscopy on the surface of the particle is 0.27 or greater.

<5> The liquid crystal polymer particle according to any one of <1> to <4>, in which a median diameter of the liquid crystal polymer particle is in a range of 0.1 μm to 30 μm.

<6> The liquid crystal polymer particle according to any one of <1> to <5>, in which the liquid crystal polymer particle contains a liquid crystal polymer having at least one unit selected from the group consisting of a constitutional unit derived from para-hydroxybenzoic acid and a constitutional unit derived from 6-hydroxy-2-naphthoic acid.

<7> The liquid crystal polymer particle according to any one of <1> to <5>, in which the liquid crystal polymer particle contains a liquid crystal polymer having at least one unit selected from the group consisting of a constitutional unit derived from 6-hydroxy-2-naphthoic acid, a constitutional unit derived from an aromatic diol compound, a constitutional unit derived from terephthalic acid, and a constitutional unit derived from 2,6-naphthalenedicarboxylic acid.

<8> A composite material comprising: the liquid crystal polymer particle according to any one of <1> to <7>; and a binder polymer.

<9> The composite material according to <8>, in which the binder polymer is a resin having at least one atom selected from the group consisting of an oxygen atom, a nitrogen atom, a sulfur atom, and a halogen atom.

<10> The composite material according to <8> or <9>, in which the binder polymer contains at least one resin selected from the group consisting of polycarbonate, polyester, polyimide, and a fluororesin.

<11> The composite material according to any one of <8> to <10>, in which the composite material has a film shape.

<12> A method of producing a liquid crystal polymer particle, comprising: an oxidation treatment step of oxidizing a surface of a liquid crystal polymer particle, in which in the obtained liquid crystal polymer particle, a difference in contact angle of the particle with water due to a water droplet in air at 25° C. and 50% RH between inside the particle and the surface of the particle is 7° or greater.

<13> A method of producing a liquid crystal polymer particle, comprising: an oxidation treatment step of oxidizing a surface of a liquid crystal polymer particle, in which in the obtained liquid crystal polymer particle, a difference in atomic ratio of an oxygen atom to a carbon atom measured by X-ray photoelectron spectroscopy between inside the particle and the surface of the particle is 0.02 or greater.

<14> The method of producing a liquid crystal polymer particle according to <12> or <13>, in which the oxidation treatment step is a step of bringing the surface of the liquid crystal polymer particle into contact with an oxidizing agent in an aqueous solution.

<15> The method of producing a liquid crystal polymer particle according to <14>, in which a standard oxidation reduction potential of the oxidizing agent is 1.50 V or greater.

<16> The method of producing a liquid crystal polymer particle according to <14> or <15>, in which the oxidizing agent contains at least one compound selected from the group consisting of sodium persulfate, potassium persulfate, ammonium persulfate, hydrogen peroxide, potassium permanganate, sodium hypochlorite, cerium ammonium nitrate, potassium chromate, potassium dichromate, and a double salt consisting of potassium peroxymonosulfate, potassium hydrogensulfate, and potassium sulfate.

<17> The method of producing a liquid crystal polymer particle according to any one of <14> to <16>, in which the oxidizing agent contains a persulfate.

<18> The method of producing a liquid crystal polymer particle according to any one of <14> to <17>, in which a pH of the aqueous solution in the oxidation treatment step is 12 or greater.

According to the aspect of the present invention, it is possible to provide liquid crystal polymer particles having excellent dispersibility in a resin or a solvent containing a polar group and a method of producing the same.

Further, according to another aspect of the present invention, it is possible to provide a composite material containing the liquid crystal polymer particles.

### DESCRIPTION OF THE PREFERRED EMBODIMENTS

Hereinafter, the contents of the present disclosure will be described in detail. The description of configuration requirements below is made based on representative embodiments of the present disclosure in some cases, but the present disclosure is not limited to such embodiments.

Further, in the present specification, a numerical range shown using “to” indicates a range including numerical values described before and after “to” as a lower limit and an upper limit.

In a numerical range described in a stepwise manner in the present disclosure, an upper limit or a lower limit described in one numerical range may be replaced with an upper limit or a lower limit in another numerical range described in a stepwise manner. Further, in a numerical range described in the present disclosure, an upper limit or a lower limit described in the numerical range may be replaced with a value described in an example.

Further, in a case where substitution or unsubstitution is not noted in regard to the notation of a “group” (atomic group) in the present specification, the “group” includes not only a group that does not have a substituent but also a group having a substituent. For example, the concept of an “alkyl group” includes not only an alkyl group that does not have a substituent (unsubstituted alkyl group) but also an alkyl group having a substituent (substituted alkyl group).

In the present specification, the concept of “(meth)acryl” includes both acryl and methacryl, and the concept of “(meth)acryloyl” includes both acryloyl and methacryloyl.

Further, the term “step” in the present specification indicates not only an independent step but also a step which cannot be clearly distinguished from other steps as long as the intended purpose of the step is achieved.

Further, in the present disclosure, “% by mass” has the same definition as that for “% by weight”, and “part by mass” has the same definition as that for “part by weight”.

Further, in the present disclosure, a combination of two or more preferred embodiments is a more preferred embodiment.

Further, the weight-average molecular weight (Mw) and the number average molecular weight (Mn) in the present disclosure are molecular weights converted using polystyrene as a standard substance by performing detection with a gel permeation chromatography (GPC) analyzer using TSKgel SuperHM-H (trade name, manufactured by Tosoh Corporation) column, a solvent of pentafluorophenol (PFP) and chloroform at a mass ratio of 1:2, and a differential refractometer, unless otherwise specified.

Liquid Crystal Polymer Particles

In a first embodiment of liquid crystal polymer particles according to the present disclosure, a difference in contact angle of the liquid crystal polymer particle with water due to a water droplet in air at 25° C. and 50% RH between inside the particle and a surface of the particle is 7° or greater.

In a second embodiment of the liquid crystal polymer particles according to the present disclosure, a difference in atomic ratio of an oxygen atom to a carbon atom measured by X-ray photoelectron spectroscopy between inside a particle and a surface of the particle is 0.02 or greater.

In a third embodiment of the liquid crystal polymer particles according to the present disclosure, the contact angle of the particle with water on the surface of the particle due to a water droplet in air at 25° C. and 50% RH is less than 65°.

In a fourth embodiment of the liquid crystal polymer particles according to the present disclosure, the atomic ratio of the oxygen atom to the carbon atom measured by X-ray photoelectron spectroscopy in a surface of a particle is 0.27 or greater.

In the present specification, the expression “liquid crystal polymer particles according to the present disclosure” or “liquid crystal polymer particles” simply denotes all the first embodiment to the fourth embodiment described above, unless otherwise specified.

In the related art, liquid crystal polymer particles do not have sufficient dispersibility in resins and dispersion media, particularly resins and dispersion media having polarity, for example, resins and dispersion media containing a polar group in many cases.

It is assumed that in a case where the surface of each of the liquid crystal polymer particles according to the present disclosure is subjected to an oxidation treatment, a difference in contact angle of the particle with water due to a water droplet in air at 25° C. and 50% RH between inside the particle and the surface of the particle is 7° or greater or a difference in atomic ratio of an oxygen atom to a carbon atom measured by X-ray photoelectron spectroscopy between inside a particle and the surface of the particle is 0.02 or greater, the contact angle of the particle with water on the surface of the particle due to a water droplet in air at 25° C. and 50% RH is less than 65°, or the atomic ratio of the oxygen atom to the carbon atom measured by X-ray photoelectron spectroscopy in the surface of a particle is 0.27 or greater, the surface of each particle is made more hydrophilic as compared with the inside of the particle, and the particle interacts with a resin or solvent containing a polar group, and thus the dispersibility of the liquid crystal polymer particles is improved.

Difference in Contact Angle of Particle with Water Due to Water Droplet in Air at 25° C. and 50% RH Between Inside Particle and Surface of Particle

In the first embodiment of the liquid crystal polymer particles according to the present disclosure, a difference in contact angle of the particle with water due to a water droplet in air at 25° C. and 50% RH between inside the particle and the surface of the particle is 7° or greater, and from the viewpoints of the dispersibility in a resin or solvent containing a polar group (hereinafter, also simply referred to as “dispersibility”) and the tensile strength in a case where a composite material contains a resin containing a polar group (hereinafter, also simply referred to as “tensile strength”), preferably in 7° or greater and 30° or less, more preferably 10° or greater and 25° or less, and particularly preferably 14° or greater and 20° or less.

In the second to fourth embodiments of the liquid crystal polymer particles according to the present disclosure, from the viewpoints of the dispersibility and the tensile strength, the difference in contact angle of the particle with water due to a water droplet in air at 25° C. and 50% RH between inside the particle and the surface of the particle is preferably 7° or greater, more preferably 7° or greater and 30° or less, still more preferably 10° or greater and 25° or less, and particularly preferably 14° or greater and 20° or less.

A method of measuring the water contact angle on the surface of a particle and the method of measuring the water contact angle inside the particle in the present disclosure are as follows.

Method of Measuring Water Contact Angle on Surface of Particle

1.5 g of liquid crystal polymer particles are placed in a 30 mmφ hand press adapter and pressed at a pressure of 900 kgf/cm² (8820 N/cm²) for 1 minute, thereby obtaining a green compact. The contact angle of the particle with water at 25° C. is measured at a temperature of 25° C. and a humidity of 50% RH. The measurement is carried out using a contact angle meter (DM700) (manufactured by Kyowa Interface Science Co., Ltd.). The contact angle is calculated by reading the values of the contact angles 5 seconds after preparation of liquid droplets on the green compact and averaging 10 values. The contact angle measured by the above-described method is defined as the water contact angle on the surface of the liquid crystal polymer particles.

Method of Measuring Water Contact Angle Inside Particle

The liquid crystal polymer particles are heated to a temperature higher than or equal to the melting point, melted, and cooled again, and the obtained polymer solid matter is ground in a mortar, thereby obtaining liquid crystal polymer particles. Since the liquid crystal polymer particles have been heated to a temperature higher than or equal to the melting point once, the original surface and the inside are considered to be completely confused. The water contact angle of the liquid crystal polymer particles obtained in the above-described manner is measured by the same method as described above and is defined as the water contact angle inside the liquid crystal polymer particles.

In the liquid crystal polymer particles, an absolute value of the difference in contact angle of the particle with water due to a water droplet in air at 25° C. and 50% RH between inside the particle and the surface of the particle is acquired by obtaining the difference between the value of the water contact angle inside the particle and the value of the water contact angle on the surface of the particle.

Contact Angle of Particle with Water on Surface of Particle Due to Water Droplet in Air at 25° C. and 50% RH

In the third embodiment of the liquid crystal polymer particles according to the present disclosure, the contact angle of the particle with water on the surface of the particle due to a water droplet in air at 25° C. and 50% RH is less than 65°, and from the viewpoints of the dispersibility and the tensile strength, preferably 50° or greater and less than 65°, more preferably 52° or greater and 64° or less, and particularly preferably 54° or greater and 60° or less.

In the first, second, or fourth embodiment of the liquid crystal polymer particles according to the present disclosure, from the viewpoints of the dispersibility and the tensile strength, the contact angle of the particle with water on the surface of the particle due to a water droplet in air at 25° C. and 50% RH is preferably less than 65°, more preferably 50° or greater and less than 65°, still more preferably 52° or greater and 64° or less, and particularly preferably 54° or greater and 60° or less.

Contact Angle of Particle with Water Inside Particle Due to Water Droplet in Air at 25° C. and 50% RH

In the liquid crystal polymer particles according to the present disclosure, from the viewpoints of the dispersibility and the tensile strength, the contact angle of the particle with water inside the particle due to a water droplet in air at 25° C. and 50% RH is preferably 65° or greater, more preferably 65° or greater and 90° or less, still more preferably 67° or greater and 85° or less, and particularly preferably 70° or greater and 80° or less.

Difference in Atomic Ratio of Oxygen Atom to Carbon Atom Measured by X-Ray Photoelectron Spectroscopy Between Inside Particle and Surface of Particle

In the second embodiment of the liquid crystal polymer particles according to the present disclosure, the difference in atomic ratio of the oxygen atom to the carbon atom measured by X-ray photoelectron spectroscopy between inside the particle and the surface of the particle is 0.02 or greater, and from the viewpoints of the dispersibility and the tensile strength, preferably 0.02 or greater and 0.10 or less, more preferably 0.02 or greater and 0.08 or less, and particularly preferably 0.03 or greater and 0.05 or less.

Further, the atomic ratio is the ratio between the numbers of atoms.

A method of measuring the atomic ratio of the oxygen atom to the carbon atom on the surface of the particle and a method of measuring the atomic ratio of the oxygen atom to the carbon atom inside the particle in the present disclosure are as follows.

Method of Measuring Atomic Ratio of Oxygen Atom to Carbon Atom on Surface of Particle

The atomic ratio of the oxygen atom to the carbon atom on the surface of the liquid crystal polymer particle (also referred to as the oxygen atom/carbon atom ratio on the surface of the particle) is measured using an X-ray photoelectron spectroscopic analyzer (“PHI 5000 VersaProbe II”, manufactured by ULVAC-PHI, Inc.). The atomic ratio measured by the above-described method is defined as the atomic ratio of the oxygen atom to the carbon atom on the surface of the liquid crystal polymer particle.

Method of Measuring Atomic Ratio of Oxygen Atom to Carbon Atom Inside Particle

The liquid crystal polymer particles are heated to a temperature higher than or equal to the melting point, melted, and cooled again, and the obtained polymer solid matter is ground in a mortar, thereby obtaining liquid crystal polymer particles. Since the liquid crystal polymer particles have been heated to a temperature higher than or equal to the melting point once, the original surface and the inside are considered to be completely confused. The atomic ratio of the oxygen atom to the carbon atom of the liquid crystal polymer particle obtained in the above-described manner is measured by the same method as described above, and this atomic ratio is defined as the atomic ratio of the oxygen atom to the carbon atom inside the liquid crystal polymer particle (also referred to as the oxygen atom/carbon atom ratio inside the particle).

In the liquid crystal polymer particles, an absolute value of the difference in atomic ratio of the oxygen atom to the carbon atom measured by X-ray photoelectron spectroscopy between inside the particle and the surface of the particle is acquired by obtaining the difference between the value of the atomic ratio of the oxygen atom to the carbon atom inside the particle and the value of the atomic ratio of the oxygen atom to the carbon atom on the surface of the particle.

Atomic Ratio of Oxygen Atom to Carbon Atom Measured by X-Ray Photoelectron Spectroscopy on Surface of Particle

In the fourth embodiment of the liquid crystal polymer particles according to the present disclosure, the atomic ratio of the oxygen atom to the carbon atom measured by X-ray photoelectron spectroscopy on the surface of the particle is 0.27 or greater, and from the viewpoints of the dispersibility and the tensile strength, preferably 0.27 or greater and 0.35 or less, more preferably 0.27 or greater and 0.32 or less, and particularly preferably 0.28 or greater and 0.30 or less.

In the first to third embodiments of the liquid crystal polymer particles according to the present disclosure, from the viewpoints of the dispersibility and the tensile strength, the atomic ratio of the oxygen atom to the carbon atom measured by X-ray photoelectron spectroscopy on the surface of the particle is preferably 0.27 or greater, more preferably 0.27 or greater and 0.35 or less, still more preferably 0.27 or greater and 0.32 or less, and particularly preferably 0.28 or greater and 0.30 or less.

Atomic Ratio of Oxygen Atom to Carbon Atom Measured by X-Ray Photoelectron Spectroscopy Inside Particle

From the viewpoints of the dispersibility and the tensile strength, the atomic ratio of the oxygen atom to the carbon atom measured by X-ray photoelectron spectroscopy on the surface of the liquid crystal polymer particle according to the present disclosure is preferably 0.15 or greater and less than 0.27, more preferably 0.20 or greater and less than 0.27, and particularly preferably 0.23 or greater and 0.26 or less.

Median Diameter

The median diameter (D50) of the liquid crystal polymer particles according to the present disclosure is not particularly limited and may be appropriately selected as desired, but is preferably in a range of 0.01 μm to 100 μm, more preferably in a range of 0.05 μm to 50 μm, still more preferably in a range of 0.1 μm to 30 μm, and particularly preferably in a range of 1 μm to 20 μm from the viewpoints of the dispersibility and the tensile strength.

The median diameter of the particles in the present disclosure is a diameter in which the total volume of particles on a large-diameter side and the total volume of particles on a small-diameter side is equal to each other in a case where the entirety of the liquid crystal polymer particles are divided into two sides of particles with a particle diameter at which the cumulative volume reaches 50% as a threshold.

In the present disclosure, the median diameter of the particles is measured using Mastersizer 2000 (manufactured by Malvern Panalytical).

Liquid Crystal Polymer

The liquid crystal polymer particles according to the present disclosure may contain a liquid crystal polymer and may further contain other resins and other components, but it is preferable that the liquid crystal polymer particles are formed of a liquid crystal polymer.

Further, from the viewpoints of the dispersibility and the tensile strength, it is preferable that the liquid crystal polymer particles according to the present disclosure are particles obtained by oxidizing the surface of each particle.

The kind of the liquid crystal polymer is not particularly limited, and a known liquid crystal polymer can be used.

Further, the liquid crystal polymer may be a thermotropic liquid crystal polymer that exhibits liquid crystallinity in a melting state or may be a lyotropic liquid crystal polymer that exhibits liquid crystallinity in a solution state. Further, in a case of the thermotropic liquid crystal polymer, it is preferable that the polymer is melted at a temperature of 450° C. or lower.

Examples of the liquid crystal polymer include liquid crystal polyester, liquid crystal polyester amide in which an amide bond is introduced into liquid crystal polyester, liquid crystal polyester ether in which an ether bond introduced into liquid crystal polyester, and liquid crystal polyester carbonate in which a carbonate bond is introduced into liquid crystal polyester.

Further, from the viewpoint of the liquid crystallinity and the linear expansion coefficient, a polymer having an aromatic ring is preferable, and aromatic polyester or aromatic polyester amide is more preferable as the liquid crystal polymer.

Further, the liquid crystal polymer may be a polymer in which an imide bond, a carbodiimide bond, a bond derived from an isocyanate such as an isocyanurate bond, or the like is further introduced into aromatic polyester or aromatic polyester amide.

Further, it is preferable that the liquid crystal polymer is a wholly aromatic liquid crystal polymer formed of only an aromatic compound as a raw material monomer.

Examples of the liquid crystal polymer include
1) a liquid crystal polymer obtained by polycondensing an aromatic hydroxycarboxylic acid (i), an aromatic dicarboxylic acid (ii), and at least one compound (iii) selected from the group consisting of an aromatic diol, an aromatic hydroxyamine and an aromatic diamine,
2) a liquid crystal polymer obtained by polycondensing a plurality of kinds of aromatic hydroxycarboxylic acids,
3) a liquid crystal polymer obtained by polycondensing an aromatic dicarboxylic acid (i) and at least one compound (ii) selected from the group consisting of an aromatic diol, an aromatic hydroxyamine, and an aromatic diamine, and
4) a liquid crystal polymer obtained by polycondensing polyester (i) such as polyethylene terephthalate and an aromatic hydroxycarboxylic acid (ii).

Here, as a part or the entirety of the aromatic hydroxycarboxylic acid, the aromatic dicarboxylic acid, the aromatic diol, the aromatic hydroxyamine, and the aromatic diamine, each and independently, a derivative that can be polycondensed may be used.

Examples of the polymerizable derivative of a compound containing a carboxy group, such as an aromatic hydroxycarboxylic acid or an aromatic dicarboxylic acid, include a derivative (ester) obtained by converting a carboxy group to an alkoxycarbonyl group or an aryloxycarbonyl group, a derivative (acid halide) obtained by converting a carboxy group to a haloformyl group, and a derivative (acid anhydride) obtained by converting a carboxy group to an acyloxycarbonyl group.

Examples of the polymerizable derivative of a compound containing a hydroxy group, such as an aromatic hydroxycarboxylic acid, an aromatic diol, or an aromatic hydroxyamine, include a derivative (acylated product) obtained by acylating a hydroxy group and converting the acylated group to an acyloxy group.

Examples of the polymerizable derivative of a compound containing an amino group, such as an aromatic hydroxyamine or an aromatic diamine, include a derivative (acylated product) obtained by acylating an amino group and converting the acylated group to an acylamino group.

From the viewpoint of the liquid crystallinity, the liquid crystal polymer has preferably a constitutional repeating unit represented by any of Formulae (1) to (3) (hereinafter, the constitutional repeating unit and the like represented by Formula (1) will also be referred to as the repeating unit (1) and the like), more preferably a constitutional repeating unit represented by Formula (1), and particularly preferably a constitutional repeating unit represented by Formula (1), a constitutional repeating unit represented by Formula (2), and a constitutional repeating unit represented by Formula (3),

—O—Ar¹—CO— Formula (1)

—CO—Ar²—CO— Formula (2)

—X—Ar³—Y— Formula (3)

in Formulae (1) to (3), AO represents a phenylene group, a naphthylene group, or a biphenylylene group, Ar² and Ar³ each independently represent a phenylene group, a naphthylene group, a biphenylylene group, or a group represented by Formula (4), X and Y each independently represent an oxygen atom or an imino group, and hydrogen atoms in the groups represented by Ar¹ to Ar³ may be each independently substituted with a halogen atom, an alkyl group, or an aryl group,

—Ar⁴—Z—Ar⁵— Formula (4)

in Formula (4), Ar⁴ and Ar⁵ each independently represent a phenylene group or a naphthylene group, and Z represents an oxygen atom, a sulfur atom, a carbonyl group, a sulfonyl group, or an alkylene group.

Examples of the halogen atom of include a fluorine atom, a chlorine atom, a bromine atom, and an iodine atom.

Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group, and an n-decyl group, and the number of carbon atoms thereof is preferably in a range of 1 to 10.

Examples of the aryl group include a phenyl group, an o-tolyl group, an m-tolyl group, a p-tolyl group, a 1-naphthyl group, and a 2-naphthyl group, and the number of carbon atoms is preferably in a range of 6 to 20.

In a case where the hydrogen atom is substituted with any of these groups, the number thereof is preferably 2 or less and more preferably 1 for each group independently represented by Ar¹, Ar², or Ar³.

Examples of the alkylene group include a methylene group, a 1,1-ethanediyl group, a 1-methyl-1,1-ethanediyl group, a 1,1-butanediyl group, and a 2-ethyl-1,1-hexanediyl group, and the number of carbon atoms thereof is preferably in a range of 1 to 10.

The repeating unit (1) is a constitutional repeating unit derived from a predetermined aromatic hydroxycarboxylic acid.

Preferred examples of the repeating unit (1) include a constitutional repeating unit in which Ar¹ represents a p-phenylene group (constitutional repeating unit derived from p-hydroxybenzoic acid), a constitutional repeating unit in which Ar¹ represents a 2,6-naphthylene group (constitutional repeating unit derived from 6-hydroxy-2-naphthoic acid), and a constitutional repeating unit in which Ar¹ represents a 4,4′-biphenylylene group (constitutional repeating unit derived from 4′-hydroxy-4-biphenylcarboxylic acid).

The repeating unit (2) is a constitutional repeating unit derived from a predetermined aromatic dicarboxylic acid.

Preferred examples of the repeating unit (2) include a constitutional repeating unit in which Ar² represents a p-phenylene group (constitutional repeating unit derived from terephthalic acid), a constitutional repeating unit in which Ar² represents an m-phenylene group (constitutional repeating unit derived from isophthalic acid), a constitutional repeating unit in which Ar² represents a 2,6-naphthylene group (constitutional repeating unit derived from 2,6-naphthalenedicarboxylic acid), and a constitutional repeating unit in which Ar² represents a diphenylether-4,4′-diyl group (constitutional repeating unit derived from diphenylether-4,4′-dicarboxylic acid).

The repeating unit (3) is a constitutional repeating unit derived from a predetermined aromatic diol, an aromatic hydroxylamine, or an aromatic diamine.

Preferred examples of the repeating unit (3) include a constitutional repeating unit in which Ar³ represents a p-phenylene group (constitutional repeating unit derived from hydroquinone, p-aminophenol, or p-phenylenediamine), a constitutional repeating unit in which Ar³ represents an m-phenylene group (constitutional repeating unit derived from isophthalic acid), and a constitutional repeating unit in which Ar³ represents a 4,4′-biphenylylene group (constitutional repeating unit derived from 4,4′-dihydroxybiphenyl, 4-amino-4′-hydroxybiphenyl, or 4,4′-diaminobiphenyl).

The content of the repeating unit (1) is preferably 30% by mole or greater, more preferably in a range of 30% by mole to 80% by mole, still more preferably in a range of 30% by mole to 60% by mole, and particularly preferably in a range of 30% by mole to 40% by mole with respect to the total amount of all constitutional repeating units (value obtained by dividing the mass of each constitutional repeating unit constituting the liquid crystal polymer by the formula weight of each repeating unit to acquire the amount (mole) equivalent to the substance amount of each constitutional repeating unit and adding up the acquired values).

The content of the repeating unit (2) is preferably 35% by mole or less, more preferably in a range of 10% by mole to 35% by mole, still more preferably in a range of 20% by mole to 35% by mole, and particularly preferably in a range of 30% by mole to 35% by mole with respect to the total amount of all constitutional repeating units.

The content of the repeating unit (3) is preferably 35% by mole or less, more preferably in a range of 10% by mole to 35% by mole, still more preferably in a range of 20% by mole to 35% by mole, and particularly preferably in a range of 30% by mole to 35% by mole with respect to the total amount of all constitutional repeating units.

The heat resistance, the strength, and the rigidity are likely to be improved as the content of the repeating unit (1) increases, but the solubility in a solvent is likely to be decreased in a case where the content thereof is extremely large.

The ratio of the content of the repeating unit (2) to the content of the repeating unit (3) is expressed as [content of repeating unit (2)]/[content of repeating unit (3)] (mol/mol) and is preferably in a range of 0.9/1 to 1/0.9, more preferably in a range of 0.95/1 to 1/0.95, and still more preferably in a range of 0.98/1 to 1/0.98.

The liquid crystal polymer may have two or more kinds of each of the repeating units (1) to (3) independently. Further, the liquid crystal polymer may have a constitutional repeating unit other than the repeating units (1) to (3), but the content thereof is preferably 10% by mole or less and more preferably 5% by mole or less with respect to the total amount of all the repeating units.

The liquid crystal polymer has preferably a repeating unit in which at least one of X or Y represents an imino group, that is, at least one of a constitutional repeating unit derived from a predetermined aromatic hydroxylamine or a constitutional repeating unit derived from an aromatic diamine as the repeating unit (3) from the viewpoint of excellent solubility in a solvent and more preferably only a repeating unit in which at least one of X or Y represents an imino group as the repeating unit (3).

Among these, from the viewpoints of the dispersibility and the tensile strength, the liquid crystal polymer particles according to the present disclosure contain preferably a liquid crystal polymer having at least one unit selected from the group consisting of a constitutional unit derived from para-hydroxybenzoic acid and a constitutional unit derived from 6-hydroxy-2-naphthoic acid and more preferably a liquid crystal polymer having a constitutional unit derived from para-hydroxybenzoic acid and a constitutional unit derived from 6-hydroxy-2-naphthoic acid.

Further, from the viewpoints of the dispersibility and the tensile strength, the liquid crystal polymer particles according to the present disclosure contain preferably a liquid crystal polymer having at least one unit selected from the group consisting of a constitutional unit derived from 6-hydroxy-2-naphthoic acid, a constitutional unit derived from an aromatic diol compound, a constitutional unit derived from terephthalic acid, and a constitutional unit derived from 2,6-naphthalenedicarboxylic acid and more preferably a liquid crystal polymer having a constitutional unit derived from 6-hydroxy-2-naphthoic acid, a constitutional unit derived from an aromatic diol compound, a constitutional unit derived from terephthalic acid, and a constitutional unit derived from 2,6-naphthalenedicarboxylic acid.

It is preferable that the liquid crystal polymer is produced by melt-polymerizing raw material monomers corresponding to the constitutional repeating units constituting the liquid crystal polymer. The melt polymerization may be carried out in the presence of a catalyst, and examples of the catalyst include metal compounds such as magnesium acetate, stannous acetate, tetrabutyl titanate, lead acetate, sodium acetate, potassium acetate, and antimony trioxide, and nitrogen-containing heterocyclic compounds such as 4-(dimethylamino)pyridine and 1-methylimidazole. Among these, the nitrogen-containing heterocyclic compounds are preferably used. The melt polymerization may be further carried out by solid phase polymerization as necessary.

The flow start temperature of the liquid crystal polymer is preferably 250° C. or higher, more preferably 250° C. or higher and 350° C. or lower, and still more preferably 260° C. or higher and 330° C. or lower. In a case where the flow start temperature of the liquid crystal polymer is in the above-described range, the solubility, the heat resistance, the strength, and the rigidity are excellent, and the viscosity of the solution is appropriate.

The flow start temperature, also referred to as a flow temperature, is a temperature at which a viscosity of 4,800 Pas (48,000 poises) is exhibited in a case where the liquid crystal polymer is melted and extruded from a nozzle having an inner diameter of 1 mm and a length of 10 mm while the temperature is raised at a rate of 4° C./min under a load of 9.8 MPa (100 kg/cm²) using a capillary rheometer and is a guideline for the molecular weight of liquid crystal polyester (“Liquid Crystal Polymers—Synthesis/Molding/Applications—”, written by Naoyuki Koide, CMC Corporation, Jun. 5, 1987, see p. 95).

Further, the weight-average molecular weight of the liquid crystal polymer is preferably 1,000,000 or less, more preferably 3,000 to 300,000, still more preferably in a range of 5,000 to 100,000, and particularly preferably in a range of 5,000 to 30,000. In a case where the weight-average molecular weight of the liquid crystal polymer is in the above-described range, the thermal conductivity, the heat resistance, the strength, and the rigidity are excellent.

From the viewpoint of the mechanical strength, the liquid crystal polymer contained in the liquid crystal polymer particles according to the present disclosure is preferably 0.01 or less, more preferably 0.005 or less, still more preferably 0.004 or less, and particularly preferably greater than 0 and 0.003 or less.

From the viewpoint of the heat resistance, the glass transition temperature Tg of the liquid crystal polymer contained in the liquid crystal polymer particles according to the present disclosure is preferably 150° C. or higher, more preferably 200° C. or higher, and particularly preferably 200° C. or higher and lower than 280° C.

The glass transition temperature Tg in the present disclosure is defined as a value measured by a differential scanning calorimetry (DSC) device.

Other Additives

The liquid crystal polymer particles according to the present disclosure may contain other additives.

Known additives can be used as other additives. Specific examples thereof include a filler, a leveling agent, an antifoaming agent, an antioxidant, an ultraviolet absorbing agent, a flame retardant, and a colorant.

Further, the liquid crystal polymer particles may contain resins other than the above-described components as other additives.

Examples of the resins other than the liquid crystal polymer include thermoplastic resins such as polyolefin, a cycloolefin polymer, polyamide, polyester, polyphenylene sulfide, polyether ketone, polycarbonate, polyethersulfone, polyphenylene ether and a modified product thereof, and polyetherimide, elastomers such as a copolymer of glycidyl methacrylate and polyethylene, and thermosetting resins such as a phenol resin, an epoxy resin, a polyimide resin, and a cyanate resin.

The total content of the other additives is preferably 25 parts by mass or less, more preferably 10 parts by mass or less, and still more preferably 5 parts by mass or less with respect to 100 parts by mass of the content of the liquid crystal polymer.

Applications

The liquid crystal polymer particle according to the present disclosure can be suitably used for various applications such as electronic components, coating materials, powder materials for a molded body, and additives. Among these, the liquid crystal polymer particle can be used more suitably for electronic components such as printed wiring boards and particularly suitably for flexible printed circuit boards.

Method of Producing Liquid Crystal Polymer Particle

A method of producing a liquid crystal polymer particle according to a first embodiment of the present disclosure is a method including an oxidation treatment step of oxidizing a surface of a liquid crystal polymer particle, in which in the obtained liquid crystal polymer particle, a difference in contact angle of the particle with water due to a water droplet in air at 25° C. and 50% RH between inside the particle and the surface of the particle is 7° or greater.

A method of producing a liquid crystal polymer particle according to a second embodiment of the present disclosure is a method including an oxidation treatment step of oxidizing a surface of a liquid crystal polymer particle, in which in the obtained liquid crystal polymer particle, a difference in atomic ratio of an oxygen atom to a carbon atom measured by X-ray photoelectron spectroscopy between inside the particle and the surface of the particle is 0.02 or greater.

A method of a producing liquid crystal polymer particle according to a third embodiment of the present disclosure is a method including an oxidation treatment step of oxidizing a surface of a liquid crystal polymer particle, in which in the obtained liquid crystal polymer particle, the contact angle of the particle with water on the surface of the particle due to a water droplet in air at 25° C. and 50% RH is less than 65°.

A method of producing a liquid crystal polymer particle according to a fourth embodiment of the present disclosure is a method including an oxidation treatment step of oxidizing a surface of a liquid crystal polymer particle, in which in the obtained liquid crystal polymer particle, the atomic ratio of an oxygen atom to a carbon atom measured by X-ray photoelectron spectroscopy on the particle surface is 0.27 or greater.

In the present specification, the expression “method of producing the liquid crystal polymer particle according to the present disclosure” or “method of producing the liquid crystal polymer particle” simply denotes all the first embodiment to the fourth embodiment of the method of producing the liquid crystal polymer particles according to the present disclosure, unless otherwise specified.

It is preferable that the liquid crystal polymer particles according to the present disclosure are liquid crystal polymer particles produced by the method of producing the liquid crystal polymer particles according to the present disclosure.

Further, in the method of producing the liquid crystal polymer particles according to the present disclosure, the preferred embodiments of the liquid crystal polymer particles to be obtained are the same as the preferred embodiments of the liquid crystal polymer particles according to the present disclosure described above.

Oxidation Treatment Step

The method of producing the liquid crystal polymer particles according to the present disclosure includes an oxidation treatment step of oxidizing the surface of each liquid crystal polymer particle.

The oxidation treatment step is preferably a step of oxidizing the surface of the liquid crystal polymer particles using an oxidizing agent and more preferably a step of bringing the liquid crystal polymer particles and the oxidizing agent into contact with each other in an aqueous solution to oxidize the surface of each liquid crystal polymer particle.

The pH of the aqueous solution is not particularly limited as long as the surface of the particle can be oxidized, but is preferably 8 or greater, more preferably 12 or greater, and still more preferably 13 or greater.

The upper limit of the pH of the aqueous solution is not limited and is, for example, 14.

The time for brining the liquid crystal polymer particles and the oxidizing agent into contact with each other in the aqueous solution is preferably in a range of 0.1 hours to 24 hours, more preferably 0.5 hours to 10 hours, and still more preferably in a range of 1.5 hours to 6 hours.

Further, the temperature of the aqueous solution in a case where the liquid crystal polymer particles and the oxidizing agent are brought into contact with each other is preferably in a range of 1° C. to 95° C., more preferably in a range of 25° C. to 80° C., and still more preferably in a range of 45° C. to 65° C.

The method of bringing the liquid crystal polymer particles and the oxidizing agent into contact with each other in the aqueous solution is not limited, and examples thereof include a method of mixing the particles and the oxidizing agent so that the particles and the oxidizing agent come into contact with each other by performing a treatment using a crusher or a grinder such as a rocking mill, a beads mill, a ball mill, a Henschel mixer, a jet mill, a star-burst, or a paint conditioner, a method of bringing the particles and the oxidizing agent into contact with each other while performing a stirring treatment using a mechanical stirrer such as a three-one motor or a magnetic stirrer, and a method of bringing the particles and the oxidizing agent into contact with each other while circulating an oxidizing agent aqueous solution containing the oxidizing agent or the like in a cartridge filled with the liquid crystal polymer particles using a pump.

In the middle of the method of bringing the particles and the oxidizing agent into contact with each other while circulating the solution, the entirety of the liquid crystal polymer particles and the oxidizing agent aqueous solution to be subjected to a modifying step are regarded as the aqueous solution as a whole even in a case where a part of the oxidizing agent aqueous solution is in contact with the liquid crystal polymer particles filling the cartridge and the other part of the oxidizing agent aqueous solution is present in the pump or the like and thus is not in contact with the liquid crystal polymer particles.

It is preferable that the liquid crystal polymer particles and the oxidizing agent are brought into contact with each other in the aqueous solution and the obtained liquid crystal polymer particles are taken out from the aqueous solution.

The method of taking out the liquid crystal polymer particles from the aqueous solution is not particularly limited, and a known method can be used, and examples of the known method include a method of filtering the aqueous solution to separate the liquid crystal polymer particles as residues.

It is also preferable that the liquid crystal polymer particles that have been taken out are washed with water, an organic solvent, or the like.

Oxidizing Agent

In the oxidation treatment step, it is preferable to use an oxidizing agent.

It is preferable that the aqueous solution contains an oxidizing agent.

The oxidizing agent is not limited, and examples thereof include a persulfate such as sodium persulfate, potassium persulfate, or ammonium persulfate, a nitrate such as cerium ammonium nitrate, sodium nitrate, or ammonium nitrate, a peroxide such as hydrogen peroxide or tert-butyl hydroperoxide, a manganese compound such as potassium permanganate or manganese dioxide, a chromium compound such as potassium chromate or potassium dichromate, a hypervalent iodine compound such as potassium periodate or sodium periodate, a quinone compound such as p-benzoquinone, 1,2-naphthoquinone, anthraquinone, or chloranil, an amine oxide compound such as N-methylmorpholine N-oxide, a salt of halogen oxo-acid such as sodium hypochlorite or sodium chlorite, and a double salt (OXONE, manufactured by Dupont) consisting of potassium peroxymonosulfate, potassium hydrogensulfate, and potassium sulfate.

Among these, from the viewpoints of the oxidizability, the dispersibility, and the tensile strength, it is preferable that the oxidizing agent includes a persulfate and more preferable that the oxidizing agent is a persulfate.

Further, from the viewpoint of the oxidizability, the aqueous solution contains, as the oxidizing agent, preferably at least one compound selected from the group consisting of sodium persulfate, potassium persulfate, ammonium persulfate, hydrogen peroxide, potassium permanganate, sodium hypochlorite, cerium ammonium nitrate, potassium chromate, potassium dichromate, and a double salt consisting of potassium peroxymonosulfate, potassium hydrogensulfate, and potassium sulfate, more preferably at least one compound selected from the group consisting of sodium persulfate, potassium persulfate, ammonium persulfate, hydrogen peroxide, sodium hypochlorite, cerium ammonium nitrate, and a double salt consisting of potassium peroxymonosulfate, potassium hydrogensulfate, and potassium sulfate, and particularly preferably at least one compound selected from the group consisting of sodium persulfate, potassium persulfate, and ammonium persulfate.

Further, a catalyst may be used separately from the oxidizing agent in order to assist the action of the oxidizing agent. Examples of the catalyst include a divalent iron compound (FeSO₄ or the like) and a trivalent iron compound.

Further, the oxidizing agent and the catalyst may be respectively a hydrate.

From the viewpoint of the oxidizability, the standard oxidation reduction potential of the oxidizing agent is preferably 0.30 V or greater, more preferably 1.50 V or greater, and still more preferably 1.70 or greater. The upper limit of the standard oxidation reduction potential of the oxidizing agent is not particularly limited, but is, for example, preferably 4.00 V or less and more preferably 2.50 V or less.

The standard oxidation reduction potential is based on the standard hydrogen electrode.

The content of the oxidizing agent in the aqueous solution is preferably in a range of 0.05 parts by mass to 20 parts by mass, more preferably in a range of 0.1 parts by mass to 20 parts by mass, and particularly preferably in a range of 1 part by mass to 20 parts by mass with respect to 100 parts by mass of water in the aqueous solution.

The oxidizing agent may be used alone or in combination of two or more kinds thereof.

In a case where the aqueous solution contains a catalyst, the content of the oxidizing agent is preferably in a range of 0.005 parts by mass to 2 parts by mass, more preferably in a range of 0.01 parts by mass to 2 parts by mass, and still more preferably in a range of 0.1 parts by mass to 2 parts by mass with respect to 100 parts by mass of water in the aqueous solution.

The catalyst may be used alone or in combination of two or more kind thereof

Alkaline Compound

It is preferable that the aqueous solution contains an alkaline compound in addition to the above-described components in order to adjust the pH of the aqueous solution.

Examples of the alkaline compound include an alkali metal hydroxide (sodium hydroxide or the like), an inorganic base such as an alkaline earth metal hydroxide, and an organic base. Among these, an alkali metal hydroxide is preferable.

The content of the alkaline compound in the aqueous solution may be appropriately adjusted such that the pH of the aqueous solution can be adjusted to a desired temperature and is for example, preferably in a range of 0.1 parts by mass to 10 parts by mass with respect to 100 parts by mass of water in the aqueous solution.

Other Steps

Further, the method of producing the liquid crystal polymer particles according to the present disclosure may include other steps.

It is preferable that the method of producing the liquid crystal polymer particles according to the present disclosure includes a step of preparing liquid crystal polymer particles used in the oxidation treatment step described above.

The liquid crystal polymer particles used in the oxidation treatment step may be prepared by a known method or a commercially available product may be used.

Further, the method of producing the liquid crystal polymer particles according to the present disclosure may include a washing step of washing the liquid crystal polymer particles obtained by the oxidation treatment step, and a drying step of drying the liquid crystal polymer particles obtained by the oxidation treatment step or the washing step.

The washing method in the washing step and the drying method in the drying step are not particularly limited, and known methods can be used.

Composite Material

The composite material according to the present disclosure contains the liquid crystal polymer particles according to the present disclosure and preferably the liquid crystal polymer particles according to the present disclosure and a binder polymer.

The shape and the size of the composite material are not particularly limited and the composite material may be an optional shape and an optional size.

Among examples, it is preferable that the composite material has a film shape. Further, from the viewpoint of the tensile strength, it is preferable that the composite material contains a binder polymer containing a polar group.

The binder polymer is not particularly limited, and examples thereof include thermoplastic resins such as polyolefin, a cycloolefin polymer, polyamide, polyester, polyphenylene sulfide, polyether ketone, polycarbonate, polyethersulfone, polyphenylene ether and a modified product thereof, and polyetherimide, elastomers such as a copolymer of glycidyl methacrylate and polyethylene, and thermosetting resins such as a phenol resin, an epoxy resin, a polyimide resin, and a cyanate resin.

In the composite material according to the present disclosure, the binder polymer may be used alone or in combination of two or more kinds thereof.

From the viewpoint of the tensile strength, the binder polymer is preferably a resin having at least one atom selected from the group consisting of an oxygen atom, a nitrogen atom, a sulfur atom, and a halogen atom, more preferably a resin having at least one atom selected from the group consisting of an oxygen atom, a nitrogen atom, and a sulfur atom, and particularly preferably a resin having at least one atom selected from the group consisting of an oxygen atom and a nitrogen atom.

Further, from the viewpoint of the tensile strength, the binder polymer contains preferably at least one resin selected from the group consisting of polycarbonate, polyester, polyimide, and a fluororesin and more preferably at least one resin selected from the group consisting of polycarbonate, polyimide, and a fluororesin.

In the composite material according to the present disclosure, the liquid crystal polymer particles may be used alone or in combination of two or more kinds thereof.

The content of the liquid crystal polymer particles in the composite material according to the present disclosure is not particularly limited and may be appropriately selected as desired, but from the viewpoint of sufficiently exhibiting the effects of the liquid crystal polymer particles, the content thereof is preferably in a range of 0.01% by mass to 70% by mass, more preferably in a range of 0.1% by mass to 60% by mass, and particularly preferably in a range of 1% by mass to 50% by mass with respect to the total mass of the composite material.

In a case where the composite material contains the binder polymer and the liquid crystal polymer particles, from the viewpoint of the tensile strength, the content of the liquid crystal polymer particles in the composite material according to the present disclosure is preferably in a range of 1% by mass to 70% by mass, more preferably in a range of 5% by mass to 60% by mass, and particularly preferably in a range of 10% by mass to 50% by mass with respect to the total mass of the composite material.

### EXAMPLES

Hereinafter, the present disclosure will be described in more detail with reference to examples. The materials, the used amounts, the ratios, the treatment contents, the treatment procedures, and the like described in the following examples can be appropriately changed without departing from the gist of the present disclosure. Therefore, the scope of the present disclosure is not limited to the following specific examples. Further, “parts” and “%” are on a mass basis unless otherwise specified.

Liquid Crystal Polymer Particles (LCP-A)

Spherical liquid crystal polymer particles were prepared with reference to Production Example 1 of WO2019/240153A. The median diameter (D50) thereof was 10 μm, the dielectric loss tangent thereof was 0.0021, and the melting point thereof was 325° C.

Liquid Crystal Polymer Particles (LCP-B)

Spherical liquid crystal polymer particles were prepared with reference to Production Example 2 of WO2019/240153A. The median diameter (D50) thereof was 40 μm, the dielectric loss tangent thereof was 0.0021, and the melting point thereof was 325° C.

### Example 1

Liquid crystal polymer particles (LCP-A) (50 parts) were added to NaOH water (NaOH: 40 parts/water: 400 parts), and the mixture was stirred. Sodium persulfate water (sodium persulfate: 9.6 parts/water: 100 parts) was added thereto, and the mixture was heated to 50° C. and further stirred for 3 hours. The mixture was stirred at 150 rpm (revolutions per minute) using a three-one motor (manufactured by Shinto Scientific Co., Ltd.). The mixture was cooled to room temperature (25° C., the same applies hereinafter), and the liquid crystal polymer particles were filtered, washed with 500 parts of water, and dried at 40° C., thereby obtaining surface-modified liquid crystal polymer particles (LCP-1).

### Example 2

Liquid crystal polymer particles (LCP-A) (50 parts) were added to NaOH water (NaOH: 40 parts/water: 400 parts), and the mixture was stirred. Sodium persulfate water (sodium persulfate: 9.6 parts/water: 100 parts) and an iron sulfate heptahydrate (1.1 parts) were added to the NaOH water, the NaOH water was heated to 50° C., and the mixture was further stirred for 3 hours. The mixture was stirred at 150 rpm (revolutions per minute) using a three-one motor (manufactured by Shinto Scientific Co., Ltd.). The mixture was cooled to room temperature, and the liquid crystal polymer particles were filtered, washed with 500 parts of water, and dried at 40° C., thereby obtaining surface-modified liquid crystal polymer particles (LCP-2).

### Example 3

Liquid crystal polymer particles (LCP-A) (50 parts) were added to water (400 parts), and the mixture was stirred to obtain a mixed solution. Sodium hypochlorite water (sodium hypochlorite pentahydrate: 9.6 parts/water: 100 parts) was added to the mixed solution, and the mixed solution was heated to 50° C. and further stirred for 3 hours. The mixture was stirred at 150 rpm (revolutions per minute) using a three-one motor (manufactured by Shinto Scientific Co., Ltd.). The mixture was cooled to room temperature, and the liquid crystal polymer particles were filtered, washed with 500 parts of water, and dried at 40° C., thereby obtaining surface-modified liquid crystal polymer particles (LCP-3).

### Example 4

Liquid crystal polymer particles (LCP-A) (50 parts) were added to NaOH water (NaOH: 40 parts/water: 400 parts), and the mixture was stirred. Cerium ammonium nitrate water (cerium ammonium nitrate: 9.6 parts/water: 100 parts) was added to the NaOH water, the NaOH water was heated to 50° C., and the mixture was further stirred for 3 hours. The mixture was stirred at 150 rpm (revolutions per minute) using a three-one motor (manufactured by Shinto Scientific Co., Ltd.). The mixture was cooled to room temperature, and the liquid crystal polymer particles were filtered, washed with 500 parts of water, and dried at 40° C., thereby obtaining surface-modified liquid crystal polymer particles (LCP-4).

### Example 5

Surface-modified liquid crystal polymer particles (LCP-5) were obtained by the same method as in Example 1 except that the sodium persulfate water in the blending of “sodium persulfate: 9.6 parts/water: 100 parts” in Example 1 was changed to sodium persulfate water in blending of “sodium persulfate: 48 parts/water: 100 parts”.

### Example 6

Surface-modified liquid crystal polymer particles (LCP-6) were obtained by the same method as in Example 1 except that the NaOH water in the blending of “NaOH: 40 parts/water: 400 parts” in Example 1 was changed to NaOH water in blending of “NaOH: 2 parts/water: 400 parts”.

### Example 7

Surface-modified liquid crystal polymer particles (LCP-7) were obtained by the same method as in Example 1 except that the sodium persulfate water in the blending of “sodium persulfate: 9.6 parts/water: 100 parts” in Example 1 was changed to potassium iodate water in blending of “potassium iodate: 9.6 parts/water: 100 parts”.

### Example 8

Surface-modified liquid crystal polymer particles (LCP-8) were obtained by the same method as in Example 1 except that the NaOH water in the blending of “NaOH: 40 parts/water: 400 parts” in Example 1 was changed to NaOH water in blending of “NaOH: 0.02 parts/water: 400 parts”.

### Example 9

Surface-modified liquid crystal polymer particles (LCP-9) were obtained by the same method as in Example 1 except that the sodium persulfate water in the blending of “sodium persulfate: 9.6 parts/water: 100 parts” in Example 1 was changed to potassium persulfate water in blending of “potassium persulfate: 9.6 parts/water: 100 parts”.

### Example 10

Surface-modified liquid crystal polymer particles (LCP-10) were obtained by the same method as in Example 1 except that the sodium persulfate water in the blending of “sodium persulfate: 9.6 parts/water: 100 parts” in Example 1 was changed to ammonium persulfate water in blending of “ammonium persulfate: 9.6 parts/water: 100 parts”.

### Example 11

Surface-modified liquid crystal polymer particles (LCP-11) were obtained by the same method as in Example 1 except that the liquid crystal polymer particles (LCP-A) in Example 1 were changed to the liquid crystal polymer particles (LCP-B).

### Comparative Example 1

The liquid crystal polymer particles (LCP-A) were used for evaluation without change.

### Comparative Example 2

Liquid crystal polymer particles (LCP-A) (50 parts) were added to NaOH water (NaOH: 40 parts/water: 400 parts), and the mixture was stirred. The mixture was heated to 50° C. and further stirred for 3 hours. The mixture was stirred at 150 rpm (revolutions per minute) using a three-one motor (manufactured by Shinto Scientific Co., Ltd.). The mixture was cooled to room temperature, and the liquid crystal polymer particles were filtered, washed with 500 parts of water, and dried at 40° C., thereby obtaining liquid crystal polymer particles (LCP-12).

### Comparative Example 3

The liquid crystal polymer particles (LCP-B) were used for evaluation without change.

### Comparative Example 4

Liquid crystal polymer particles (LCP-B) (50 parts) were added to NaOH water (NaOH: 40 parts/water: 400 parts), and the mixture was stirred. The mixture was heated to 50° C. and further stirred for 3 hours. The mixture was stirred at 150 rpm (revolutions per minute) using a three-one motor (manufactured by Shinto Scientific Co., Ltd.). The mixture was cooled to room temperature, and the liquid crystal polymer particles were filtered, washed with 500 parts of water, and dried at 40° C., thereby obtaining liquid crystal polymer particles (LCP-13).

Measurement Conditions

—Method of Measuring Water Contact Angle on Surface of Particle—

1.5 g of liquid crystal polymer particles (LCP-1 to 13 or LCP-A or LCP-B) were placed in a 30 mmφ hand press adapter and pressed at a pressure of 900 kgf/cm² (8,820 N/cm²) for 1 minute, thereby obtaining a green compact. The contact angle of the particle with water at 25° C. was measured at a temperature of 25° C. and a humidity of 50% RH. The measurement was carried out using a contact angle meter (DM700) (manufactured by Kyowa Interface Science Co., Ltd.). The contact angle was calculated by reading the values of the contact angles 5 seconds after preparation of liquid droplets on the green compact and averaging 10 values. The contact angle measured by the above-described method was defined as the water contact angle on the surface of the liquid crystal polymer particles (LCP-1 to 13 or LCP-A or B).

Method of Measuring Water Contact Angle Inside Particle

The liquid crystal polymer particles (LCP-1 to 13 or LCP-A or B) were heated to a temperature higher than or equal to the melting point, melted, and cooled again, and the obtained polymer solid matter was ground in a mortar, thereby obtaining liquid crystal polymer particles. Since the liquid crystal polymer particles have been heated to a temperature higher than or equal to the melting point once, the original surface and the inside are considered to be completely confused. The water contact angle of the liquid crystal polymer particles obtained in the above-described manner was measured by the same method as described above and was defined as the water contact angle inside the liquid crystal polymer particles (LCP-1 to 13 or LCP-A or B).

The water contact angle on the particle surface of the liquid crystal polymer particles (LCP-A or B) before the surface modification treatment was the same as the water contact angle inside the particles.

Further, the water contact angle of the particle with water inside the liquid crystal polymer particles (LCP-1 to 13) was the same as the water contact angle of the particle with water on the particle surface of the liquid crystal polymer particles (LCP-A or B) and the water contact angle of the particle with water inside the liquid crystal polymer particles before the surface modification treatment.

Method of Measuring Atomic Ratio of Oxygen Atom to Carbon Atom on Surface of Particle

The atomic ratio (oxygen proportion on the particle surface) of the oxygen atom to the carbon atom on the surface of the liquid crystal polymer particles (LCP-1 to 13 or LCP-A or B) was measured using an X-ray photoelectron spectroscopic analyzer (“PHI 5000 VersaProbe II” manufactured by ULVAC-PHI, Inc.). The atomic ratio measured by the above-described method was defined as the atomic ratio of the oxygen atom to the carbon atom on the surface of the liquid crystal polymer particle (LCP-1 to 13 or LCP-A or B).

Method of Measuring Atomic Ratio of Oxygen Atom to Carbon Atom Inside Particle

The liquid crystal polymer particles (LCP-1 to 13 or LCP-A or B) were heated to a temperature higher than or equal to the melting point, melted, and cooled again, and the obtained polymer solid matter was ground in a mortar, thereby obtaining liquid crystal polymer particles. Since the liquid crystal polymer particles have been heated to a temperature higher than or equal to the melting point once, the original surface and the inside are considered to be completely confused. The atomic ratio of the oxygen atom to the carbon atom of the liquid crystal polymer particle obtained in the above-described manner was measured by the same method as described above, and this atomic ratio was defined as the atomic ratio of the oxygen atom to the carbon atom inside the liquid crystal polymer particles (LCP-1 to 13 or LCP-A or B).

The atomic ratio of the oxygen atom to the carbon atom on the particle surface of the liquid crystal polymer particles (LCP-A or B) before the surface modification treatment was the same as the atomic ratio of the oxygen atom to the carbon atom inside the particles.

Further, the atomic ratio of the oxygen atom to the carbon atom inside the liquid crystal polymer particles (LCP-1 to 13) was the same as the atomic ratio of the oxygen atom to the carbon atom on the particle surface and inside the liquid crystal polymer particles (LCP-A or B) before the surface modification treatment.

Evaluation

Dispersibility in Resin or Solvent

1 g of the liquid crystal polymer particles (LCP-1 to 13) or untreated liquid crystal polymer particles (LCP-A or B) were dispersed in 20 mL of a 10 mass % aqueous solution of an acrylamide monomer (FOM-03007, manufactured by FUJIFILM Wako Pure Chemical Corporation), and the aggregated particle diameter during the dispersion was measured using Particle Track G400 (manufactured by Mettler-Toledo International Inc.). It can be said that the dispersibility is excellent as the aggregated particle diameter thereof decreases.

The evaluation was performed based on the relative values with the average particle diameters (LCP-A: 10 μm, LCP-B: 40 μm) obtained by measuring the untreated liquid crystal polymer particles (LCP-A or LCP-B) by a dry air pressure dispersion method. LCP-1 to 10 and 12 were compared with LCP-A, and LCP-11 and 13 were compared with LCP-B. Further, the measurement according to the dry air pressure dispersion method was performed using Mastersizer 2000 (manufactured by Malvern Panalytical).

The evaluation was performed by comparison with the average particle diameter (LCP-A: 10 μm, LCP-B: 40 μm) obtained by measuring LCP-A or LCP-B using the dry air pressure dispersion method.

A: The aggregated particle diameter (D₅₀) was less than 1.5 times

B: The aggregated particle diameter (D₅₀) was 1.5 times or greater and less than 3 times

C: The aggregated particle diameter (D₅₀) was 3 times or greater

Tensile Strength

Polycarbonate Resin

Polycarbonate having an intrinsic viscosity [η] (methylene chloride, 25° C.) of 0.50 dl/g which was produced by melt polymerization of bisphenol A and diphenyl carbonate. A polycarbonate resin in which the equivalent ratio (I)/(II) of a phenolic terminal group (I) to a non-phenolic terminal group (II) was 3/7 was used.

Polyimide Resin

A polyimide resin was synthesized and used with reference to Synthesis Example 1 of JP2000-191908A

Polytetrafluoroethylene (PTFE) Resin

G163 (polytetrafluoroethylene resin particles, average particle diameter of 25 μm, manufactured by AGC Inc.) was used.

Liquid Crystal Polymer Particles

The obtained liquid crystal polymer particles (LCP1 to 13) or the untreated liquid crystal polymer particles (LCP-A or B) were used.

Measurement of Tensile Strength

80 parts by mass of the polycarbonate resin and 20 parts by mass of the liquid crystal polymer particles were mixed at such a mixing ratio and kneaded and extruded by a 30 mmφ twin-screw extruder at a barrel set temperature of 280° C. and a rotation speed of 300 rpm to prepare pellets. Further, test pieces were prepared using the completed pellets by an injection molding machine at a cylinder temperature of 280° C. and a mold temperature 80° C.

Three test pieces each having a width of 10 mm, a length of 50 mm, and a thickness of 0.5 mm were prepared, and the temperature and the humidity were adjusted for 24 hours in an atmosphere of 23° C. and a relative humidity of 40%. The sample pieces having a width of 10 mm were set such that the chuck distance reached 30 mm, and a tensile test was performed at a tensile speed of 10 mm/min to measure the tensile strength using a Tensilon tensile tester.

The evaluation was carried out by performing measurement three times in each direction and acquiring the average value thereof.

In addition, the evaluation was performed based on the relative values with the tensile strength measured by preparing test pieces using the untreated liquid crystal polymer particles.

A: 1.3 times or greater

B: 1.2 times or greater and less than 1.3 times

C: 1.1 times or greater and less than 1.2 times

D: less than 1.1 times

Further, in a case where the tensile strength was measured using a polyimide resin or a polytetrafluoroethylene (PTFE) resin, the polyimide resin or the polytetrafluoroethylene (PTFE) resin was used in place of the polycarbonate resin described above.

TABLE 1

| | | | | | | | | | | Oxygen atom/ | | | |
|---|---|---|---|---|---|---|---|---|---|---|---|---|---|
| | Liquid crystal | | Oxidizing agent | | | | pH of | Contact | | carbon | | | |
| | polymer | | | Standard | | | aqueous | angle | | atom ratio | | Evaluation | |
| | particles | | | oxidation | Addi- | | solution | | Value | | Value | result | |
| | | Addition | | reduction | tion | Type | of during | Value | of in- | Value | of sur- | Dis- | Ten- |
| | | amount | | potential | amount | of cat- | oxidation | of sur- | side - | of sur- | face - | pers- | sile |
| | Name | (parts) | Type | (V) | (parts) | alyst | treatment | face | surface | face | inside | ibility | strength |
| Example 1 | LCP-1 | 50 | Sodium | 2.01 | 9.6 | — | 14 | 56° | 18° | 0.28 | 0.03 | A | A |
| | | | persulfate | | | | | | | | | | |
| Example 2 | LCP-2 | 50 | Sodium | 2.01 | 9.6 | Iron | 14 | 56° | 18° | 0.28 | 0.03 | A | A |
| | | | persulfate | | | sulfate | | | | | | | |
| | | | | | | hepta- | | | | | | | |
| | | | | | | hydrate | | | | | | | |
| Example 3 | LCP-3 | 50 | Sodium | 1.63 | 9.6 | — | 12 | 63° | 11° | 0.27 | 0.02 | B | B |
| | | | hypo- | | | | | | | | | | |
| | | | chlorite | | | | | | | | | | |
| Example 4 | LCP-4 | 50 | Cerium | 1.74 | 9.6 | — | 14 | 61° | 13° | 0.27 | 0.02 | B | B |
| | | | ammonium | | | | | | | | | | |
| | | | nitrate | | | | | | | | | | |
| Example 5 | LCP-5 | 50 | Sodium | 2.01 | 48 | — | 14 | 55° | 19° | 0.29 | 0.04 | A | A |
| | | | persulfate | | | | | | | | | | |
| Example 6 | LCP-6 | 50 | Sodium | 2.01 | 9.6 | — | 13 | 57° | 17° | 0.28 | 0.03 | A | A |
| | | | persulfate | | | | | | | | | | |
| Example 7 | LCP-7 | 50 | Potassium | 1.20 | 9.6 | — | 14 | 64° | 10° | 0.27 | 0.02 | B | B |
| | | | iodate | | | | | | | | | | |
| Example 8 | LCP-8 | 50 | Sodium | 2.01 | 9.6 | — | 11 | 62° | 12° | 0.27 | 0.02 | B | B |
| | | | persulfate | | | | | | | | | | |
| Example 9 | LCP-9 | 50 | Potassium | 2.01 | 9.6 | — | 14 | 56° | 18° | 0.28 | 0.03 | A | A |
| | | | persulfate | | | | | | | | | | |
| Example 10 | LCP-10 | 50 | Ammonium | 2.01 | 9.6 | — | 14 | 56° | 18° | 0.28 | 0.03 | A | A |
| | | | persulfate | | | | | | | | | | |
| Example 11 | LCP-11 | 50 | Sodium | 2.01 | 9.6 | — | 14 | 56° | 18° | 0.28 | 0.03 | A | A |
| | | | persulfate | | | | | | | | | | |
| Comparative | LCP-A | — | — | — | — | — | — | 74° | 0° | 0.25 | 0 | C | D |
| example 1 | | | | | | | | | | | | | |
| Comparative | LCP-12 | 50 | — | — | — | — | 14 | 68° | 6° | 0.25 | 0.01 | C | C |
| example 2 | | | | | | | | | | | | | |
| Comparative | LCP-B | — | — | — | — | — | — | 74° | 0° | 0.25 | 0 | C | D |
| example 3 | | | | | | | | | | | | | |
| Comparative | LCP-13 | 50 | — | — | — | — | 14 | 68° | 6° | 0.25 | 0.01 | C | C |
| example 4 | | | | | | | | | | | | | |

In regard to the tensile strength, in the liquid crystal polymer particles (LCP-1 to 11) of Examples 1 to 11, the same effect of improving the tensile strength was obtained even in a case where the polyimide resin or the polytetrafluoroethylene (PTFE) resin was used in place of the polycarbonate resin.

Further, the same effect of improving the tensile strength was obtained even in a case where the mixing ratio of the polycarbonate resin and the liquid crystal polymer was set to 50 parts by mass of the polycarbonate resin and 50 parts by mass of the liquid crystal polymer particles.

As listed in Table 1, the liquid crystal polymer particles (LCP-1 to 11) of Examples 1 to 11 had excellent dispersibility in a resin or a solvent containing a polar group as compared with the liquid crystal polymer particles (LCP-12 or 13 or LCP-A or B) of Comparative Examples 1 to 4.

Further, as listed in Table 1, a composite material with excellent tensile strength was obtained in a case where the liquid crystal polymer particles (LCP-1 to 11) of Examples 1 to 11 were mixed with a resin containing a polar group (such as a polycarbonate resin, a polyimide resin, or a PTFE resin) to obtain a composite material.

What is claimed is:

1. A liquid crystal polymer particle,
wherein a difference in contact angle of the liquid crystal polymer particle with water due to a water droplet in air at 25° C. and 50% RH between inside the particle and a surface of the particle is 7° or greater.

2. A liquid crystal polymer particle,
wherein a difference in atomic ratio of an oxygen atom to a carbon atom measured by X-ray photoelectron spectroscopy between inside a particle and a surface of the particle is 0.02 or greater.

3. The liquid crystal polymer particle according to claim 1,
wherein the contact angle of the particle with water on the surface of the particle due to the water droplet in air at 25° C. and 50% RH is less than 65°.

4. The liquid crystal polymer particle according to claim 1,
wherein an atomic ratio of an oxygen atom to a carbon atom measured by X-ray photoelectron spectroscopy in the surface of the particle is 0.27 or greater.

5. The liquid crystal polymer particle according to claim 1,
wherein a median diameter of the liquid crystal polymer particle is in a range of 0.1 μm to 30 μm.

6. The liquid crystal polymer particle according to claim 1,
wherein the liquid crystal polymer particle contains a liquid crystal polymer having at least one unit selected from the group consisting of a constitutional unit derived from para-hydroxybenzoic acid and a constitutional unit derived from 6-hydroxy-2-naphthoic acid.

7. The liquid crystal polymer particle according to claim 1,
wherein the liquid crystal polymer particle contains a liquid crystal polymer having at least one unit selected from the group consisting of a constitutional unit derived from 6-hydroxy-2-naphthoic acid, a constitutional unit derived from an aromatic diol compound, a constitutional unit derived from terephthalic acid, and a constitutional unit derived from 2,6-naphthalenedicarboxylic acid.

8. A composite material comprising:
the liquid crystal polymer particle according to claim 1; and
a binder polymer.

9. The composite material according to claim 8,
wherein the binder polymer is a resin having at least one atom selected from the group consisting of an oxygen atom, a nitrogen atom, a sulfur atom, and a halogen atom.

10. The composite material according to claim 8,
wherein the binder polymer contains at least one resin selected from the group consisting of polycarbonate, polyester, polyimide, and a fluororesin.

11. The composite material according to claim 8,
wherein the composite material has a film shape.

12. A method of producing a liquid crystal polymer particle, comprising:
an oxidation treatment step of oxidizing a surface of a liquid crystal polymer particle,
wherein in the obtained liquid crystal polymer particle, a difference in contact angle of the particle with water due to a water droplet in air at 25° C. and 50% RH between inside the particle and the surface of the particle is 7° or greater.

13. A method of producing a liquid crystal polymer particle, comprising:
an oxidation treatment step of oxidizing a surface of a liquid crystal polymer particle,
wherein in the obtained liquid crystal polymer particle, a difference in atomic ratio of an oxygen atom to a carbon atom measured by X-ray photoelectron spectroscopy between inside the particle and the surface of the particle is 0.02 or greater.

14. The method of producing a liquid crystal polymer particle according to claim 12,
wherein the oxidation treatment step is a step of bringing the surface of the liquid crystal polymer particle into contact with an oxidizing agent in an aqueous solution.

15. The method of producing a liquid crystal polymer particle according to claim 14,
wherein a standard oxidation reduction potential of the oxidizing agent is 1.50 V or greater.

16. The method of producing a liquid crystal polymer particle according to claim 14,
wherein the oxidizing agent contains at least one compound selected from the group consisting of sodium persulfate, potassium persulfate, ammonium persulfate, hydrogen peroxide, potassium permanganate, sodium hypochlorite, cerium ammonium nitrate, potassium chromate, potassium dichromate, and a double salt consisting of potassium peroxymonosulfate, potassium hydrogensulfate, and potassium sulfate.

17. The method of producing a liquid crystal polymer particle according to claim 14,
wherein the oxidizing agent contains a persulfate.

18. The method of producing a liquid crystal polymer particle according to claim 14,
wherein a pH of the aqueous solution in the oxidation treatment step is 12 or greater.
